(19) United States
(12) Patent Application Publication
(10) Pub. No.: US 2003/0005461 A1
(43) Pub. Date: Jan. 2, 2003

(54) System and method for linking closed captioning to web site

(75) Inventor: Hiroaki Shinohara, San Diego, CA (US)

Correspondence Address: John L. Rogitz, Rogitz & Associates, Suite 3120, 750 B Street, San Diego, CA, 92101, US

(73) Assignee: SONY CORPORATION, Tokyo (JP)

(21) Appl. No.: 09/898,697

(22) Filed: Jul. 2, 2001

(51) Int. Cl. H04N 7/173; H04N 7/087

(52) U.S. Cl. 725/110; 725/109; 725/111; 725/112; 725/113; 348/478

(57) ABSTRACT

A system and method for automatically linking closed captioning to Web sites, based on a viewer selection of a word or phrase displayed in a closed captioning window of a TV. A microprocessor associated with the TV can automatically access the Web using as an entering argument the selected word or phrase from the closed captioning, so that a viewer can obtain further information regarding televised content.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

In the above context, the present invention recognizes that in one aspect of a lean-back experience, a viewer might be interested in knowing further aspects of televised content. For instance, a viewer might be interested in knowing more about an animal being featured on a nature program. Conventionally, the viewer might be directed to access a Web site associated with the nature channel to find out more about the animal, but this requires the viewer to stop viewing the program and operate a Web-enabled appliance or remember to access the Web site at a later time, when the viewer's interest might have waned. The present invention critically observes that it would be advantageous to provide a TV viewer with a means to obtain non-televised information pertaining to televised content in a manner that is more convenient than is currently afforded.

### SUMMARY OF THE INVENTION

A system for accessing a wide area computer network based on a viewer-selected portion of televised closed captioning includes a TV and a processor coupled to the TV in such a manner as to allow the processor to receive televised closed captioning content, preferably content that is selected by the viewer. The processor accesses the network based on the received closed captioning content.

Preferably, the processor receives a viewer selected portion of the closed captioning content. An input device that is manipulable to establish the selected portion is provided. Also, a data storage can be provided for storing closed captioning content.

As contemplated herein, the processor can access a search engine and input, as a search term or phrase, the selected portion of the closed captioning content. Or, the processor can access a wide area network site using a URL derived from the selected portion.

In another aspect, a method for accessing a wide area network site based on televised closed captioning includes receiving the closed captioning at a television receiver, and receiving a viewer selection of a selected portion of the closed captioning. The network site is automatically accessed based on the selected portion.

In still another aspect, a system for linking televised content to wide area computer network content includes means for receiving the televised content, it being understood that the televised content includes alpha-numeric characters. The system also includes means for receiving a viewer selection of the characters. Means responsive to the viewer selection automatically access a wide area network site.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is a flow chart of the present logic.

### DETAILED DESCRIPTION OF THE PREFERRED EMBODIMENTS

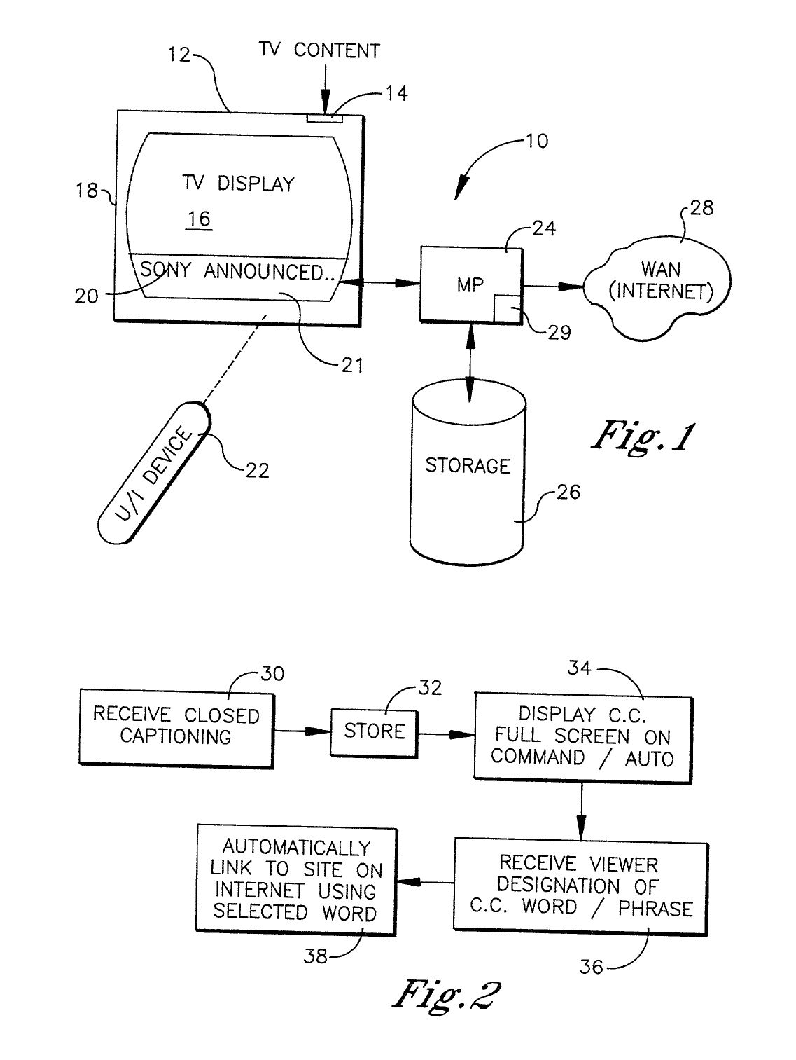

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16.

While the embodiment below discusses a TV 12 with a single housing that is shown separate from the microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor discussed below. In a less preferred embodiment, the microprocessor discussed below can be a standalone computer such as a PC or laptop with its own monitor (not shown), and can communicate with the TV 12 by wired or wireless link or simply by transferring data from the TV to the computer using, e.g., a floppy diskette.

In the preferred non-limiting embodiment shown, the TV 12 includes a housing 18 that holds a conventional television tuner which receives the TV signals. The audio and video settings of the TV, i.e., the volume, tone, tint, color, contrast, and so on as conventionally provided in the art, are established by respective adjustable audio and video setting circuits. Also, the TV 12 can display alpha-numeric closed captioning content 20, received in the TV signal, in a closed captioning window 21 on the monitor 16 in accordance with principles known in the art. The closed captioning content 20 can be selectively displayed by a viewer by appropriately manipulating a remote control user input device 22 or other controls located on the housing 18. It is to be understood that while FIG. 1 shows that the U/I device 22 can be a conventional TV remote control device, other devices can be used, such as but not limited to keyboards, keypads, mice, touch screen technology, voice activation/recognition technology, etc.

A microprocessor 24 receives the closed captioning content 20 and can store all or portions of it in a database 26. As intimated above, the preferred microprocessor 24 is integrated with the TV 12 (in the housing 18 or in a separate but associated housing such as a set top box) in such a manner as to receive the closed caption content automatically.

The microprocessor 24 can also communicate with a wide area network, such as but not limited to the Internet 28, via cable or wire modem, DSL link, wireless link, or other network link in accordance with principles known in the art to access computer sites on, e.g., the World Wide Web. As intimated above, the microprocessor 24 (and/or the database 26) can be located in the housing 18 or it can be disposed elsewhere, such as in a set-top box, remote control U/I device 22, etc. In any case, the microprocessor 24 accesses a software-implemented link module 29 to execute the logic set forth herein. The database 26 can be contained in computer memory, or on a hard disk drive, optical drive, solid state storage, tape drive, removable flash memory, or any other suitable data storage medium.

It may now be appreciated that the microprocessor 24 undertakes the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

Now referring to the logic diagram shown in FIG. 2, the link module 29 receives closed captioning content at block 30. The closed captioning content can be stored at block 32. Stored or real-time closed captioning can be automatically displayed or selectively displayed at block 34 in response to a viewer manipulation of the U/I device 22.

In accordance with present principles, at block 36 the link module 29 can receive a viewer designation of a word or phrase in the closed captioning. The viewer designation can be made by appropriately manipulating the U/I device 22 to highlight the selected word or phrase. For instance, in FIG. 1 the word “Sony” might be highlighted by the viewer.

Proceeding to block 38, when the viewer highlights the desired word or phrase, the microprocessor 24 automatically accesses a wide area network (WAN) site, such as but not limited to an Internet site, based on the word or phrase. The access can be undertaken as soon as the viewer highlights the word or phrase or only in response to a subsequent viewer input indicating that the Internet should be accessed. As non-limiting examples, a search engine site can be accessed and the highlighted word or phrase from the closed captioning automatically input by the microprocessor 24 as a search term. Or, a Web site associated with the highlighted word or phrase can be accessed by, e.g., prepending “www.” and appending “.com” to the word or phrase to render a Uniform Resource Locator (URL) that a browser associated with the microprocessor 24 can use to access the Web site. In such an embodiment, in the exemplary embodiment wherein the word “Sony” is highlighted, the microprocessor 24 would automatically generate “www.sony.com” as a URL, with the Sony web site then being automatically accessed. In this way, a viewer can obtain additional information about a closed captioning word or phrase on the TV.

While the particular SYSTEM AND METHOD FOR LINKING CLOSED CAPTIONING TO WEB SITE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

I claim:

1. A system for accessing a wide area computer network based on a viewer-selected portion of televised closed captioning, comprising:
a TV; and
a processor coupled to the TV and receiving televised closed captioning content, the processor accessing at least one site in the network based at least partially thereon.

2. The system of claim 1, wherein the processor receives a viewer selected portion of the closed captioning content, the processor accessing at least one site in the network based at least partially on the selected portion.

3. The system of claim 2, further comprising an input device manipulable to establish the selected portion.

4. The system of claim 1, further comprising a data storage for storing closed captioning content, the data storage being accessible to the processor.

5. The system of claim 2, wherein the processor accesses a wide area network search engine and inputs as a search term or phrase at least portions of the selected portion of the closed captioning content.

6. The system of claim 2, wherein the processor accesses a wide area network site using a URL derived at least in part from the selected portion.

7. A method for accessing at least one wide area network site based at least in part on televised closed captioning, comprising:
receiving the closed captioning at a television receiver;
receiving at least one viewer selection of at least a selected portion of the closed captioning; and
automatically accessing the network site based at least in part on the selected portion.

8. The method of claim 7, wherein the act of receiving is undertaken by receiving a remote control signal.

9. The method of claim 7, further comprising storing the closed captioning.

10. The method of claim 7, further comprising:
accessing a search engine; and
inputting as a search term or phrase at least portions of the selected portion.

11. The method of claim 7, further comprising:
accessing a wide area network site using a URL derived at least in part from the selected portion.

12. A system for linking televised content to wide area computer network content, comprising:
means for receiving the televised content, the televised content including alpha-numeric characters;
means for receiving a viewer selection of at least some of the characters; and
means responsive to the viewer selection for automatically accessing a wide area network site.

13. The system of claim 12, further comprising means for storing at least some of the characters.

14. The system of claim 12, wherein the means for accessing accesses a search engine and inputs as a search term or phrase at least portions of the viewer selection.

15. The system of claim 12, wherein the means for accessing accesses a wide area network site using a URL derived at least in part from the viewer selection.

16. The system of claim 12, wherein the alpha numeric characters are closed captioning.

17. The system of claim 16, wherein the closed captioning is displayed in a closed captioning window associated with the means for receiving televised content.

18. The system of claim 12, wherein the viewer selection is received from a user input device.

19. The system of claim 12, wherein the means for receiving televised content is a television.

20. The system of claim 12, wherein the means for receiving televised content includes a processor.
